(19) United States
(12) Patent Application Publication
(10) Pub. No.: US 2018/0104998 A1
(43) Pub. Date: Apr. 19, 2018

(54) PINTLE HITCH CONNECTOR

(71) Applicant: Terry Green, Jasper, AL (US)

(72) Inventor: Terry Green, Jasper, AL (US)

(21) Appl. No.: 15/296,541

(22) Filed: Oct. 18, 2016

(51) Int. Cl. B60D 1/02

(52) U.S. Cl. CPC B60D 1/025

(57) ABSTRACT

A pintle hitch connector, which includes a cylindrical trailer contact portion, a threaded portion extending from the cylindrical base with cylindrical walls. A threaded portion is provided distal to the trailer contact portion, where the threaded portion includes a hole to accommodate a locking mechanism or retainer pin. The end of the trailer contact cylinder distal to the threaded portion has a load securing pin extrusion bisecting its circumference. The load securing pin has a hole in the insertion end of the shaft to accommodate a locking mechanism or some retaining pin, and inserts into the hole running the length of the load securing pin extrusion.

### BACKGROUND OF THE INVENTION

### Field of Invention

The present invention relates to a pintle hitch assembly that includes a a pintle hitch connector.

### Description of Related Art

A tow hitch is a device that is attached to a vehicle for towing a trailer. Although hitches are used on all types of motor vehicle most the hitches are related to trucks attaching a trailer of some type for towing purposes. There are various types of trailer hitches that are associated with various load capacity. Many times trailer hitches include various components and parts that can be difficult to assemble and install and ensure a sturdy attachment of the trailer. The number of hitches include a ball coupling that allows a user to attach the trailer onto a ball and secure the trailer to the hitch through a locking mechanism associated with the ball coupling. Other alternative types of couplings or hitches include a pintle hook or a lunette ring. Both these types of couplings allow more relative motion between the trailer and the tow vehicle than a ball coupling. However, the pintle hitch in particular may be difficult to assemble onto a conventional hitch vehicle.

### SUMMARY OF THE INVENTION

The present invention relates to a pintle hitch connector, which includes a cylindrical trailer contact portion, a threaded portion extending from the cylindrical base with cylindrical walls. A threaded portion is provided distal to the trailer contact portion, where the threaded portion includes a hole to accommodate a locking mechanism or retainer pin. The end of the trailer contact cylinder distal to the threaded portion has a load securing pin extrusion bisecting its circumference. The load securing pin has a hole in the insertion end of the shaft to accommodate a locking mechanism or some retaining pin, and inserts into the hole running the length of the load securing pin extrusion.

### BRIEF DESCRIPTION OF DRAWINGS

FIG. 1 depicts a pintle hitch assembly in accordance with the present invention.

FIG. 2 depicts a vertical view of the pintle hitch connector in accordance with the present invention.

FIG. 3 depicts a reverse view of the pintle hitch connector in accordance with the present invention.

FIG. 4 depicts the pintle hitch connector with the connecting pin removed.

### DETAILED DESCRIPTION

The present invention relates to a pintle hitch assembly that provides an easier mechanism for towing purposes. This pintle hitch assembly according to the present invention has a universal connecter and includes five components.

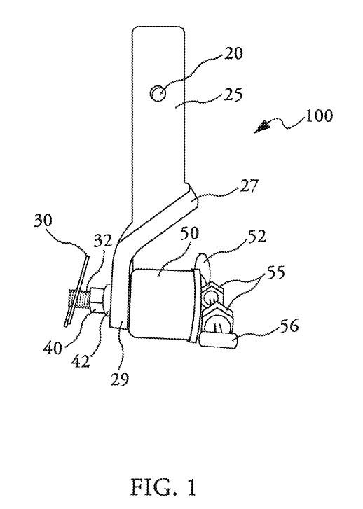

In reference to FIG. 1, a pintle hitch assembly 100 in accordance to the present invention is depicted. The pintle hitch assembly 100 includes a hitch 25 with a mounting hole 20. At the bottom end of the hitch 25 is a hitch bracket 27, where the hitch bracket 27 is curved at approximately a 45-degree angle with a connection portion 29 extending vertically. The connection portion 29 provides a means to attach a pintle hitch connector 50. A threaded bolt 32 extends from the pintle hitch connector 50 connecting the pintle hitch connector 50 to the hitch 25.

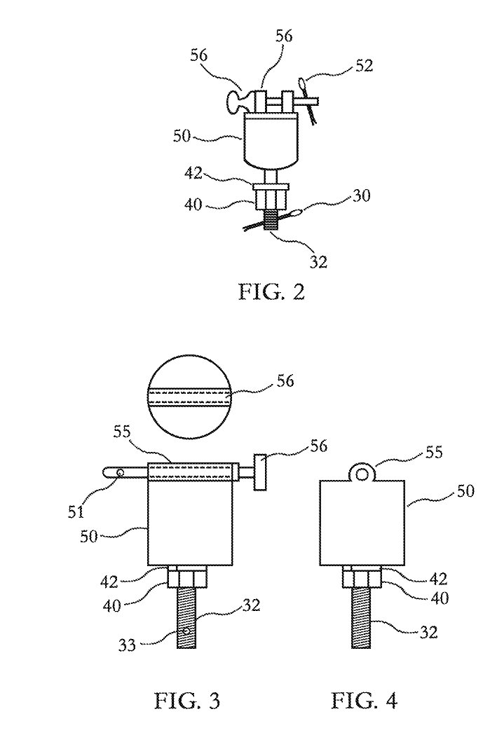

FIG. 2 shows a view of the pintle hitch connector 50 detached from the hitch 25 with a connection pin 56 inserted along with a locking pin 52. The locking pin 52 ensures that the connection pin 56 remains in place. An additional locking pin 30 is shown going through the threaded bolt 32. A connecting nut 40 and locking washer 42 are used on the threaded bolt 32 to connect the hitch connector 50 to the hitch 25 as shown in FIG. 1.

An alternative view is found in FIG. 3 with the locking pins 30, 52 removed. With the locking pin 52, an opening 51 is exposed at the distal end of the connection pin 56. FIG. 4 shows a counter view of the pintle hitch connector 50 exposing an opening 55 that receives the connection pin 56. Further in FIG. 3, opening 33 is shown in bolt 32 that receives locking pin 30 as shown in FIG. 1.

The pintle hitch connector 50 is cylindrical in shape and enables the connection and securing of various trailer hitches due to its securing pin and locking mechanisms available. This particular pintle hitch assembly 100 is easy to attach to a vehicle due to the configuration of the components and easy accessibility of the connecting or receiving pin 56. Further the device has less cost involved in manufacturing and would be available as a cheaper alternative for a pintle hitch assembly. The instant invention has been shown and described in what it considers to be the most practical and preferred embodiments. It is recognized, however, that departures may be made there from within the scope of the invention and that obvious modifications will occur to a person skilled in the art.

What is claimed is:

1. An universal quick-connect pintle hitch connector comprising:
a load-securing portion;
a threaded connecting securing portion; and
a trailer contact portion, wherein said load-securing portion includes a quick-connect load-securing pin adapted to be used with a lockable mechanism, wherein said threaded connecting securing portion includes a perpendicular hole through a threaded shaft allowing use of a lockable mechanism along with a lock washer and a nut to securely connect to any pre-drilled plate, hitch, bumper or draw bar and where said trailer contact portion provides cylindrical walls for contact with trailer for towing.

2. The pintle hitch connector according to claim 1, wherein the connector includes a cylindrical body for trailer contact.

3. The pintle hitch connector according to claim 2, further including a threaded shaft extending from the cylindrical body for trailer contact.

4. The pintle hitch connector according to claim 2, further including a hole in a threaded shaft distal to the trailer contact cylinder for securing with lockable mechanism used with the lock washer and nut.

5. The pintle hitch connector according to claim 2, further including a load-securing pin holding extrusion located at the top of the trailer contact cylinder bisecting a top circumference.

6. The pintle hitch connector according to claim 1, further including a hole lengthwise through a load-securing pin holding extrusion for the load-securing pin.

7. The pintle hitch connector according to claim 1, further including a load-securing pin with a hole in an insertion end of a shaft for securing with a lockable mechanism.
